(19) United States
(12) Patent Application Publication
(10) Pub. No.: US 2026/0208128 A1
(43) Pub. Date: Jul. 23, 2026

(54) METHODS AND SYSTEMS FOR CO-FEEDING PLASTIC WASTE-OIL BLENDS INTO A REFINERY REACTOR

(71) Applicant: Braskem S.A., Camaçari (BR)

(72) Inventors: Jesus Waldemar Gonçalves Da Silva, São Paulo City (BR); Maria Ignez Broglio, São Paulo City (BR); Robson Pablo Sobradiel Peguin, São Paulo City (BR); Steven Michael Krupinski, Philadelphia, PA (US)

(73) Assignee: Braskem S.A., Camaçari (BR)

(21) Appl. No.: 19/455,489

(22) Filed: Jan. 21, 2026

Related U.S. Application Data
(60) Provisional application No. 63/747,707, filed on Jan. 21, 2025.

(51) Int. Cl. B01F 23/40; B01F 23/43; B01F 23/45; B01F 23/47; B01F 23/70; B01F 23/80; B01F 25/431; B01F 27/70; B01F 27/722; B01F 27/724; B01F 27/91; B01F 33/82; C10B 53/07; C10B 55/00; C10G 11/00; C10G 25/00; C10G 31/00; C10G 31/09

(52) U.S. Cl. CPC B01F 23/49; B01F 23/405; B01F 23/43; B01F 23/45; B01F 23/471; B01F 23/482; B01F 23/711; B01F 23/807; B01F 23/808; B01F 25/431; B01F 27/70; B01F 27/722; B01F 27/724; B01F 27/91; B01F 33/8212; C10B 53/07; C10B 55/00; C10G 11/00; C10G 25/006; C10G 31/00; C10G 31/09; C10G 2300/1003; C10G 2300/1077; C10G 2300/201; C10G 2300/202; C10G 2300/205; C10G 2300/302

(57) ABSTRACT

A method for recycling a plastic waste including feeding a plastic waste and optionally a fluid oil into a primary mixer to produce a homogenous blend removing contaminants from the homogenous blend to produce a refinery feed stream and introducing the refinery feed stream to a refinery process unit. A feed system including a plastic feeder for dosing a plastic waste, a primary mixer and optionally a secondary mixer, one or more fluid oil inlets for providing portions of oil to the primary and optionally the secondary mixer, wherein the primary mixer and the secondary mixer are configured to form a homogenous blend from the fluid oil and the melted waste material, a contaminant removal unit connected to the primary mixer and/or the secondary mixer for removing contaminants from the homogenous blend, and a feed system outlet for feeding the homogenous blend to a refinery oil stream.

### BACKGROUND

The management of the polymer-based material lifecycle is important to maintain balance in a circular economy, particularly in products containing plastics. Plastics are commonly derived from petroleum sources and are generally non-biodegradable, therefore the need to build sustainable and effective post-industrial polymer recycling processes is felt across most industries on an international scale. The creation of a sustainable solution to address polymer waste will provide a future-focused vision for industries and address environmental and economic concerns.

Plastics are inexpensive, easy to mold, require low energy to produce and are and lightweight with many commercial applications. Generally, plastics are formed from virgin material, resin produced directly from petrochemical feedstock, such as natural gas or crude oil, which has never been used or processed before. Once the products have outlived their useful lives, they are generally sent to waste disposal such as landfill sites, adding to serious environmental problems, like land, water, and air pollution. In addition, the disposal costs for the post-industrial plastic waste poses an extra disposal cost burden on resin processors and manufacturers. Also, there is the consideration that a high demand to produce more virgin resin material places a burden on an already limited and depleting natural resource.

Plastic waste is traditionally disposed of by land filling, incineration, or recycling by mechanical reprocessing the waste into raw material for reuse. The use of post-industrial and post-consumer polymers (“plastic waste”) through recycling has a variety of benefits over producing virgin resin. Unfortunately, while the economic, environmental, and even political demand for products made from recycled plastic exists, the added value created by conventional recycling methods is comparatively low. As a result, large amounts of post-consumer waste (PCW) plastics can only be partially returned to the economic cycle. Moreover, conventional methods of recycling plastics tend to produce products with lower physical properties than the original ones as these can be diminished due to cross-contamination with other PCW or other materials present in the waste stream.

In addition to the technological limitations of conventional recycling methods, economic issues also impact the demand for plastic waste-based products. For example, the processes for extrusion of recycled plastic material may involve significant and costly cleaning pre-process steps like segregating, dry washing, wet washing and pelletizing. The commercial viability of these processes may be impacted when the extrusion process and the product thereof is not of a level of quality as of a virgin resin material.

Even the political landscape impacts the recycling market. When international markets stop investing in domestic recycling streams, waste that would have otherwise gone to foreign recyclers is redirected to domestic landfills. The domestic infrastructure is not equipped to absorb and process the large amount of certain plastics entering in the waste stream, despite the pressure for domestic industries to do so.

Despite the challenges associated with recycling plastic waste such as polyethylene and polypropylene, there is a global push to bring innovative ways of recycling plastic waste to market.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for recycling a plastic waste including feeding a plastic waste and optionally a fluid oil into a primary mixer to produce a homogenous blend removing contaminants from the homogenous blend to produce a refinery feed stream and introducing the refinery feed stream to a refinery process unit.

In another aspect, embodiments disclosed herein relate to a feed system including a plastic feeder for dosing plastic waste, a primary mixer and optionally a secondary mixer, one or more fluid oil inlets for providing portions of oil to the primary and optionally the secondary mixer, wherein the primary mixer and the secondary mixer are configured to form a homogenous blend from the fluid oil and the melted waste material, a contaminant removal unit connected to the primary mixer and/or the secondary mixer for removing contaminants from the homogenous blend, and a feed system outlet for feeding the homogenous blend to a refinery oil stream.

In yet another aspect, embodiments disclosed herein relate to a composition in the form of a homogeneous blend. The homogeneous blend includes from 1 to 50 wt % of a post-consumer waste material and from 50-99 wt % of a fluid oil. The homogeneous blend may be formed according to the embodiments disclosed above and as set forth below. Other aspects and advantages of the claimed subject matter will be apparent from the following description and the appended claims.

### BRIEF DESCRIPTION OF DRAWINGS

FIG. 1 is a depiction of a feed system 100 for recycling a plastic waste in a refinery oil stream, according to one or more embodiments.

FIG. 2 is a depiction of a feed system 200 for recycling a plastic waste in a refinery oil stream, according to one or more embodiments.

FIG. 3 is a depiction of a feed system 300 for recycling a plastic waste in a refinery oil stream, according to one or more embodiments.

FIG. 4 is a depiction of a feed system 400 for recycling a plastic waste in a refinery oil stream, according to one or more embodiments

FIG. 5 is a depiction of a feed system 500 for recycling a plastic waste in a refinery oil stream, according to one or more embodiments

FIG. 6 is a depiction of a feed system 600 for recycling a plastic waste in a refinery oil stream, according to one or more embodiments

FIG. 7 is a depiction of post-consumer waste-oil blend dynamic viscosity data.

FIG. 8 is a depiction of horizontal paddle-mixer as described in Example 3.

FIG. 9 shows a mixing vessel with a 2-stage impeller as a stirring element in accordance with Example.

FIG. 10 shows an impeller for a mixing vessel in accordance with Example 4.

FIGS. 11A-11B show designed impellers in accordance with Example 4.

FIGS. 12A-12B shows optical microscopy images of plastic waste-oil blend at 8× (scale bar: 2 mm) and 35× magnification (scale bar: 500 μm), respectively, in accordance with Example 10.

FIGS. 13A-13B show optical microscopy images (scale bars: 1,800 μm and 900 μm, respectively) of virgin plastic with neither water nor air bubbles in accordance with Example 12.

### DETAILED DESCRIPTION

Most refineries cannot use plastic waste as feedstock to their process units, including FCC (fluid catalytic cracking), hydrocracking, delayed coking, visbreaking, Flexicoking, and pyrolysis unit. Generally, a co-feeding unit is required to dissolve plastic waste in refinery oil, and it keeps plastic waste-oil blend properties within refinery specifications which include viscosity, Conradson carbon number, concentration of contaminants, and concentration of undissolved/inorganic matter. The plastic waste-blend may then be fed into one or more process units, FCC, hydrocracking, delayed coking, visbreaking, Flexicoking, and pyrolysis unit. Therefore, the resulting process unit chosen to receive the blend is a function of plastic waste-oil properties.

In one aspect, embodiments disclosed herein relate to methods and systems for recycling plastic wastes in to a refinery oil stream. Plastic waste may include but are not limited to polymers, residual plastics, post-consumer waste (PCW) materials, and flexible waste materials. Plastic wastes also include post industrial waste. Post-industrial recycled (PIR) content is plastic waste or scrap generated at a manufacturer of plastic films, sheets, foams, and injection molded articles prior to producing a finished product that has been handled and disposed of by a consumer (also referred to as pre-consumer recycled content (PCC)). In particular, embodiments disclosed herein may co-feed such plastic wastes with an oil stream into a refinery process unit through a process that provides for melting the plastic waste and mixing it with oil to form a homogenous plastic waste-oil blend. Advantageously, the presently described methods and systems may also allow for contaminant removal prior to mixing the plastic waste-oil blend being fed into a refinery process unit, with the blend properties being within specifications required for refinery processes. Methods for contaminant removal include filtration and adsorption. In addition, embodiments of the presently described methods and systems may allow for recycling plastic wastes without significantly changing the downstream processes.

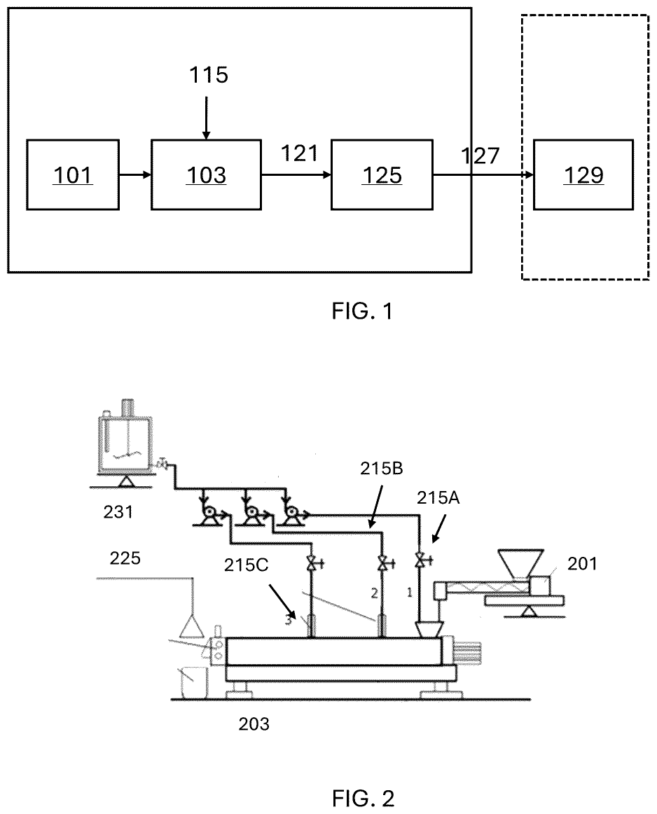

FIG. 1 is a depiction of a feed system 100 for recycling plastic waste, according to one or more embodiments. Feed system 100 includes a plastic waste source/feeder 101 connected to a plastic waste mixer: primary mixer/melting extruder 103. Primary mixer 103 has an outlet 121 connecting it with a contaminant removal unit 125. The outlet of the contaminant removal system 125 directs a homogenous blend 127 to a refinery process unit 129. The feed system 100 may also include one or more hydrocarbon inflow conduits, or feeder oil inlets 115, that are connected directly or indirectly to a refinery oil stream(s). The feed system 100 may also include one or more vents for volatile contaminant removal.

In FIG. 1, a plastic waste from the polymer plastic residue feeder source 101 is introduced into primary mixer 103, where it is melted to produce a melt of the introduced material. The plastic waste may be introduced by a gravimetric doser to the primary mixer. In one or more embodiments, primary mixer 103 may comprise any suitable equipment capable of melting and conveying a plastic waste apparent to one of ordinary skill in the art. These may include, but are not limited to, extruders such as twin-screw extruders or single-screw extruders as shown in feed system of FIG. 2. The primary mixer may also comprise equipment such as a mixing vessel or a paddle-mixer. The mixing system may include one or more mixers with an axial mixer per system that has one or more mixing blades or paddles per mixer. The mixing system may include a helicoidal or radial mixer or even one stage of high shear turbine or even a combination of these type of mixers. A primary mixer vent (not shown) may also be present for N₂ addition and for the removal of volatile components from the primary mixer 103.

A hydrocarbon inflow conduit, or fluid oil inlet 115, may be used to introduce a fluid oil from a refinery oil offshoot to the primary mixer 103. The oil from the oil inlet may also be fed gravimetrically from a buffer tank, or any suitable vessel capable of storing a heated oil. Fluid oil may be introduced via inlet 115 downstream of the introduction of a plastic waste such that plastic waste has already begun to melt upon the introduction of fluid oil. Thus, the oil addition may also occur at several points along the primary mixer 103. Upon the addition of the fluid oil, the plastic waste melt is at least partially dissolved in the fluid oil, where upon mixing, the plastic waste melt and the fluid oil form a homogenous blend. The homogenous blend then exits primary mixer 103 for downstream processing.

An advantage of the primary mixer lies in the dissolution and mixing of the plastic waste in the fluid oil where the plastic waste constitutes from 1 to 50 wt. % of the combined stream that is dissolved and mixed into a homogenous blend within in a single piece of equipment. As a non-limiting example, a granulated or agglomerated PCW may be fed into an extruder by a gravimetric doser to obtain 1 to 50 wt. % of the PCW in the PCW-oil blend. As shown in FIG. 2, a plastic waste may be introduced to a primary mixer using a gravimetric doser 201. In FIG. 2, the primary mixer 203 is a single-screw extruder with a screw profile specially developed to receive oil from an oil tank 231 at up to 3 inlet points (215A, 215B, 215C) in the extrusion cylinder so that perfect homogenization of the melted plastic waste with oil is possible. The blend may exit the extruder 203 for sampling and for volatile contaminant/gas removal with vent 225. The resulting homogeneous plastic waste-oil blend may have a higher viscosity than pure oil, but its viscosity can be adjusted through heat exchangers and thus the viscosity may be adjusted to be within refinery specifications for a feed material.

Similar performance may be achieved with the use of a mixing vessel as the primary mixer. The granulated or agglomerated PCW may be slowly added into the mixing vessel by a gravimetric doser to obtain 1 to 50 wt. % of the PCW in the PCW-oil blend. Heated oil may be continuously added into the mixing vessel. Mixing system may operate in a condition of P/V (power/volume) in a range of 0.1 to 2.0 kW/m³. The mixing speed may be adjusted to produce a homogeneous dissolution of PCW in oil. This configuration also allows for the production of a PCW-oil blend as the final product. A paddle-mixer may also be used for the primary melting extruder. For instance, the same granulated or agglomerated PCW may be added. Oil may be added at several points along the paddle-mixer resulting in a homogeneous PCW-oil blend.

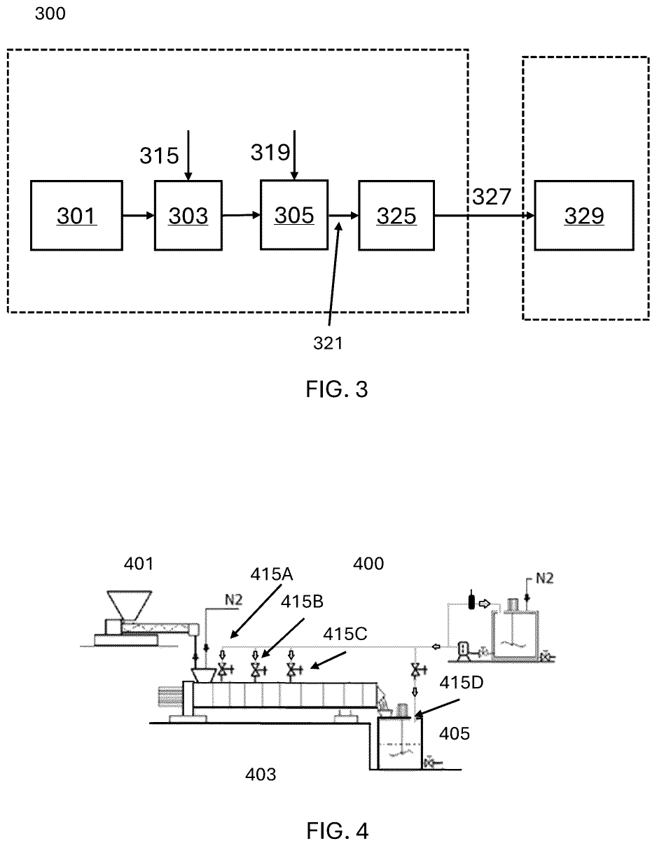

In another aspect, embodiments disclosed herein relate to a dual mixer configuration to generate a homogenous PCW-oil blend. As shown in FIG. 3, the melted plastic waste and optionally a small fraction of oil (e.g., up to 10 wt. % or between 5 to 10 wt. %) are continuously fed into the extruder and the remainder of the oil is introduced into a mixer with the melted plastic waste to obtain the homogenous plastic waste-oil blend. The oil may be fed to the extruder at a point further along the screw after the polymer is sufficiently melted in the screw compression zone through viscous shear dissipation. If the oil is added prior to shear melting, the oil may cause slippage at the barrel wall and screw and may limit the shear heating and melting of the polymer. Specifically, the melted plastic waste from the plastic waste feeder source 301 is introduced to extruder 303, where it is melted to produce a plastic waste melt. In one or more embodiments, the extruder 303 is a twin-screw extruder or single-screw extruder. The extruder may contain port(s) (not shown) which may be used to introduce nitrogen to blanket the molten polymer system to reduce the concentration of oxygen which can oxidize and discolor the molten polymer. The ports may also function as vents for the removal of volatile components including moisture or decomposition gases from the extruder 303. The vents may be at atmospheric pressure, or slightly above atmospheric pressure or even operated under vacuum to facilitate removal of impurities. One or more hydrocarbon inflow conduit, or feeder oil inlet(s) 315, may be present in the embodiments of FIG. 3, where it may optionally convey a fluid oil from a refinery oil offshoot (not shown) to the extruder 303.

As noted above, optionally, a small fraction/portion of oil may be continuously introduced via fluid oil inlet 315 downstream of the introduction of plastic waste such that plastic waste has already begun to melt upon the introduction of fluid oil. For instance, the addition of oil to the extruder may be required to reduce the viscosity of the melt. However, if the viscosity of the plastic waste melt is below 100 centipoises at 300° C., an addition of oil may not be required in the extruder.

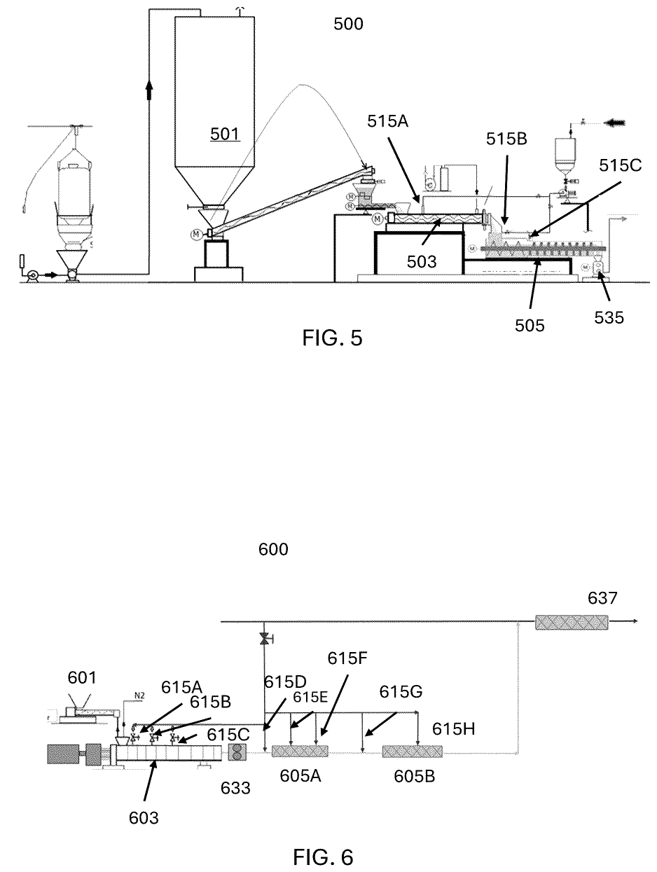

The blend, comprising the plastic waste melt and the fluid oil, exits the extruder 303 and is then received by the mixer 305, where it is mixed, and additional (the remainder) fluid oil is added via secondary fluid oil inlet 319. Upon mixing, the addition of the oil to the melted plastic waste forms the plastic waste-oil blend. The mixer 305 may comprise any equipment capable of mixing the plastic waste slurry with the fluid oil. These may include, but are not limited to, a mixing vessel as shown in the feed system 400 in FIG. 4, a paddle-mixer as shown in the feed system 500 in FIG. 5, or a low shear inline static or a high shear dynamic inline mixer as shown in the feed system 600 in FIG. 6, or a colloids mill, for conditions where plastic may be present in higher concentration in the oil. The remainder of the oil may also be introduced to a mixer that is a series of inline mixers specifically designed with heating jackets to operate at the same temperatures as the extrusion. A mixer vent may also be present for the removal of volatile contaminants from the mixer 305.

In addition to the mixers, the neat polymer melt of the polymer-oil solution may be filtered to remove contaminants prior to being delivered to the downstream reactor system. For this purpose, a continuous dual filter system may be used where the system is designed to alternate between two filters so that internal contaminants including metals, ceramics, paper, and insoluble polymers can be removed. As a non-limiting example of the dual filter system, one filter may be operating while the second is being backflushed or changed. Another example may be the use of a continuous rotary drum filter where the contaminants are continuously scraped off the surface of a rotating drum as the cleaned polymer melt passes through the drum screen. Further, depending upon the nature of the contaminant, the filter may be placed either upstream or downstream of the high-shear colloidal mill device.

Upon the addition of fluid oil, the melted plastic waste material is at least partially dissolved in the fluid oil, ultimately producing a homogenous plastic waste-oil blend when further mixed. Advantageously, the dual mixer configuration provides a reduction in size of melting extruder thereby reducing overall equipment cost and capital expenditure as compared to the use of a single primary mixer alone. This allows for a minimal amount of oil in the beginning of the mixing process and for the remaining oil to be incorporated into the melt in the secondary mixer.

As a non-limiting example, FIG. 4 depicts feed system 400. In FIG. 4, the feed system 400 includes plastic waste feeder/doser 401 to introduce the plastic waste to the extruder 403. The extruder 403 may be a single or twin-screw extruder. Small fractions of oil (e.g., 5 to 10 wt. %) may be continuously fed through a number of oil inlets (415A/415B/415C) into the extruder 403 and the remainder of the oil is introduced from another inlet 415D into a mixing vessel 405 to obtain the final plastic waste-oil blend, which is the final product of this process. The blend may then be fed from the mixer 405 to a refinery process unit.

In FIG. 5, the feed system 500 includes the granulated or agglomerated plastic waste for processing. The plastic waste may be fed from a feeder after separation of contaminants and then fed a gravimetric doser to an extruder 503. The extruder 503 may be a single or twin-screw extruder, adding or not a small amount of oil at inlet 515A, somewhere between 5 and 10 wt. %, to reduce the viscosity of the plastic waste melt. A remainder of the fluid oil may be introduced by inlet(s) 515B/515C that go into a continuous mixer 505 such as the depicted horizontal paddle-mixer. The paddle-mixer may then feed the blend to a refinery process unit using a product pump 535.

In another example, and as shown in FIG. 6, the feed system may include a plastic waste feeder 601 that introduces the plastic wastes to an extruder 603. The extruder shown may be a single or twin-screw extruder. The extruder 603 may include a number of fluid inlets 615A/615B/615C that introduce portions of fluid oil from a refinery process to the extruder. Remaining portions of the fluid oil may be introduced downstream of the extruder and introduction of the plastic waste. As shown in FIG. 6, the fluid oil may be introduced at inlet 615D after a melt pump 633 as well as through inlets (615E/615F/615G/615H) connected to the inline static or dynamic mixers 605A/605B. After the inline mixers, the blend may be fed with additional refinery oil, to a refinery process unit 637.

The series of inline mixers specially designed for this process, with heating jackets, operating in the same temperature range as the extrusion, resulting in a homogeneous plastic waste-oil blend. The plastic waste-oil blend has higher viscosity than pure oil, but its viscosity can be adjusted through heat exchangers using steam, furnace or electrical heating, to meet refinery specifications. The extruder may have a screw design profile specially developed to receive oil at up to 3 liquid inlets in the extrusion cylinder so that perfect homogenization of the melted plastic waste with the initial oil fraction is possible, just to reduce the viscosity, facilitating the final incorporation of the remainder of oil into the inline mixers as the systems mixer.

In one or more embodiments, extruder may be selected based on the melting properties of the plastic waste or may be selected based on the mixing of the plastic waste and fluid oil, as adding too much fluid oil prior to melting in primary mixer may slow the melting and/or dissolution of the plastic waste in one or more embodiments.

In keeping with FIGS. 1 and 3, after the formation of the homogenous blends, the blend exits via stream 121/321 and is then introduced into a contaminant removal unit 125/325. While the contaminant removal unit 125/325 is depicted as a separate and individual downstream step/unit, the contaminant removal may also be integrated with the vents of any of mixers or extruders described herein. The contaminant removal unit may also include filters and/or sieves, inline or independent, to remove insoluble contaminants. However, any suitable contaminant removal method/unit known in the art may be used.

Ultimately, the embodiments disclosed herein provide a final plastic waste-oil blend with suitable viscosity and other properties that are required in further processing in refinery units. The blend 127/327 exiting the contaminant removal unit 125/325 may then be fed to a refinery process unit 129/329. The refinery oil unit may then take the refinery oil and plastic waste solution downstream to any number of refinery processes. These refinery processes may include, but are not limited to, a delayed coking unit, Flexicoking, pyrolysis units, a fluid catalytic cracking unit, a visbreaking unit, or a hydrocracking unit. The viscosity of the plastic waste solution and refinery oil stream may be tailored to the conditions of an individual refinery and its refinery process units by changing the fluid oil concentration in the plastic waste solution and to allow for further processing of the plastic waste solution.

According to one or more embodiments, the fluid oil may comprise one or more hydrocarbon fluids or oil streams that may be present in a refinery. These include, but are not limited to, crude oil, vacuum atmospheric residue, atmospheric residue, vacuum gas oil (VGO), heavy mineral oil, light cycle oil (LCO) and residual oils. The fluid oil may be a heated oil at a temperature ranging from 150 to 200° C., such as from a lower limit of any one of 150, 160 or 170° C. to an upper limit of 180, 190, or 200° C., where any lower limit may be paired with any upper limit. The temperature of the oil may be maintained in the buffer tank described above or any suitable vessel capable of applying and/or maintaining a temperature of the oil. The oil may also be heated with heating jackets. Preferably, the temperature of the oil is the same temperature range as the extrusion which may range from 180 to 250° C. The oil may be introduced to the mixer(s) using an oil pump that will provide the desired percentages of PCW and oil to obtain the viscosity defined by the process.

The plastic waste may be a flexible or non-flexible post-industrial recycle (PIR) or post-consumer waste recycle (PCR) material including a mixture of polymers. The polymers may be plastic waste polymers, recycled polymers, virgin polymers or a combination thereof, comprising, for example, one or more of polyethylene, polypropylene, polybutene, polybutadiene, ethylene-vinyl acetate polymer, polystyrene, polyacrylate (e.g. poly(methyl methacrylate) (PMMA)), ethylene vinyl alcohol (EVOH) polymer, co-polymers, or mixtures thereof. The plastic waste may be powdered, granulated, agglomerated, flaked (shredded sheet) or in pelletized form. The plastic waste may also be present in different sizes, suitable sizes being ≤6 mm, such as from a lower limit of any of 0.1, 2, 3 or 4 mm to an upper limit of 4.5, 5 or 6 mm, where any lower limit may be mathematically paired with any upper limit. As a non-limiting example, the plastic waste may be a PCW collected from a landfill, processed through selection, washed and dried. The dried PCW may then be passed through a binder, granulator or agglomerator, extruder. Therefore, the waste material may be in the form of granules, powder, crushed chunks, slurry, films, melt, fines, shavings, chips, pellets, flakes, nurdles, scraps, or a mixture of these. The PCW may be present in an amount of 1 to 50 wt. % in the PCW-oil blend.

One or more polymer contaminants may also be present in the plastic waste. Contaminants that may be present include polyethylene terephthalate, polyvinyl chloride, polycarbonate, polyamides, nylon, polytetrafluoroethylene (PTFE), polyvinyl fluoride (PVF) or any combination of these. Inorganic contaminants from the polymers may also be present and include but are not limited to fillers, additives, catalysts and other materials that may be added to polymers during their production. Insoluble and/or inorganic contaminants may also be present. Inorganic and non-limiting examples of contaminants known by refineries are Ca, Cu, Fe, N, Na, Ni, Fe, S, and V. Thus, in one or more embodiments, there may be a filter and/or sieves located in the path of the plastic waste and/or the plastic waste-oil blend, such as after primary mixer 103 to remove insoluble components. Such insoluble components may comprise cross-contaminants such as sand, glass, ceramics, sand, pieces of metal such as stainless steel and iron, undissolved plastics, or other contaminants. Filters may be cleaned manually or automatically in a continuous or periodic fashion. Contaminants may negatively affect operating conditions, catalyst activity and life, reactor metallurgy and other refinery process conditions downstream.

As outlined above, the contaminant removal units may also be integrated into the mixers and/or extruders. It is also envisioned that one or more volatile contaminants may also be present in the plastic waste feed. It may be desired to remove these volatile contaminants to prevent them from entering downstream processes. Accordingly, the configurations described herein may also provide methods to remove contaminants from blends of plastic wastes and oil. The contaminants may be either homogeneous or heterogeneously dispersed in refinery oil, which may dictate the most appropriate method to remove them. Contaminant removal methods such as filtration or bed absorption/adsorption may be installed either at the main co-feeding mixer equipment or on its downstream and before the refinery processing/co-processing unit.

As described above, the mixers may have one or more vents that are operable to remove contaminants, especially volatile contaminants from the final plastic waste-oil blend. These vents may operate under vacuum, under atmospheric pressure, or under other pressures apparent to those of ordinary skill in the art. Vacuum is defined as a pressure that is less than atmospheric pressure. These vents may be present in suitable configurations in addition to those shown in FIGS. 1 and 3. The volatile contaminants may include, but are not limited to, water, air, oxygen, HCl, chlorine gas, volatile silicon compounds, and mixtures thereof. Some non-limiting examples of volatile silicon compounds include siloxanes and silanes. One or more HCl neutralizing agents, such as calcium oxide, calcium carbonate, or caustic solution, may be added to the plastic waste, to one or more of the fluid oil streams, or to both.

While other embodiments and configurations are possible. In addition, it is also envisioned that more than the single oil inlet shown may be present in extruders and mixers of any of the embodiments may have more than one feeder oil inlet. The secondary mixer may also include more than one fluid oil inlet. Furthermore, one or more of the oil inlets may convey fluid oil from a different refinery stream into the feed system. In addition, the feeder oil inlet(s) may be in a configuration wherein the plastic waste melt is combined with a fluid oil to at least partially dissolve the plastic waste melt into the fluid oil in the primary mixer extruder 103/303, and/or the secondary mixer 305. Thus, the homogenous blend may be generated in the primary and/or the secondary mixer depending on the configuration and the introduction of the fluid oil.

After contaminant removal, the final PCW-oil blend may have desirable properties as a result of homogenous blending between the plastic waste and the oil. The resultant plastic waste-oil blend may therefore be suitable for use as a feedstock to downstream refinery processing units. The plastic waste-oil blend may comprise the plastic waste in a range from 1 to 50 wt. %, such as from a lower limit of any one of 1, 5, 10, 20 or 25 wt. % to an upper limit of any one of 30, 35, 40 or 50 wt. %, where any lower limit may be mathematically paired with any upper limit. The plastic waste-oil blend may comprise the oil in an amount ranging from 99 to 50 wt. %, sch as from a lower limit of any one of 50, 55, 60 or 70 wt. % to an upper limit of any one of 75, 80, 90, 95 or 99 wt. %, where any lower limit may be mathematically paired with any upper limit.

The plastic waste-oil blend may exhibit a desirable dynamic viscosity dependent upon the concentration of the plastic waste. The maximum viscosity is up to 30,000 cP at 40° C.

The PCW-oil blend may also possess a desirable Conradson carbon number, with a maximum Conradson number of 29 wt. %.

Inorganic contaminant concentration in the blend may be determined using thermogravimetric analysis. Further, loading of PCW contaminants can also be adjusted in the PCW-oil blend by dilution, as shown in. The maximum total inorganic content was up to 23.7 wt. % and the maximum moisture content was up to 1 wt. %.

### EXAMPLES

### Example 1 Single-Screw Extruder

The primary mixer is a single-screw extruder with screw diameter of 90 mm and length to diameter ratio of 34. It has 1 barrel, 2 oil injection ports, 7 temperature zones, and 1 die. The 1^{st} oil inlet is located at feed zone #3, the 2^{nd} one is located at zone, #6. Oil temperature was kept at 100° C. Oil injectors were kept at 200° C. using heating tapes. Table 1 lists the feeding conditions, Table 2 and Table 3 the zone temperatures, Table 4 the process conditions, and the dynamic viscosity and physical aspect of PCW-VGO blends. PCW properties are listed in 6.

TABLE 1
Feeding conditions for single-screw extruder

| Trial | PCW | VGO | PCW | VGO | Total |
|---|---|---|---|---|---|
| # | wt. % | wt. % | Kg/h | Kg/h | Kg/h |
| 1 | 1.0 | 99.0 | 1.0 | 99.0 | 100 |
| 2 | 2.0 | 98.0 | 0.5 | 99.5 | 100 |
| 3 | 5.0 | 95.0 | 5.0 | 95.0 | 100 |
| 4 | 8.7 | 91.3 | 8.7 | 91.3 | 100 |
| 5 | 15.0 | 85.0 | 15.0 | 85.0 | 100 |
| 6 | 32.0 | 68.0 | 8.7 | 18.5 | 27.2 |
| 7 | 50.0 | 50.0 | 15.0 | 15.0 | 30.0 |

TABLE 2
Set zone temperatures of single-screw extruder.

| | |
|---|---|
| Zone | Temperature ° C. |

| # | Trials 1-6 | Trial 7 |
|---|---|---|
| 1 - PCW feed | 160 | 160 |
| 2 | 250 | 250 |
| 3 - VGO feed | 250 | 250 |
| 4 | 250 | 250 |
| 5 | 250 | 280 |
| 6 - VGO feed | 250 | 280 |
| 7 | 250 | 280 |

TABLE 3
Measured zone temperatures of single-screw extruder

| | Temperature | | | | | | |
|---|---|---|---|---|---|---|---|
| Zone | ° C. | | | | | | |
| # | Trial 1 | Trial 2 | Trial 3 | Trial 4 | Trial 5 | Trial 6 | Trial 7 |
| 1 - PCW feed | 157-167 | 155-167 | 156-162 | 158-161 | 157-164 | 153-164 | 158-161 |
| 2 | 229-250 | 231-250 | 241-251 | 249-251 | 248-252 | 249-251 | 249-251 |
| 3 - VGO feed | 247-251 | 248-251 | 247-252 | 250-251 | 250-250 | 249-251 | 248-251 |
| 4 | 240-250 | 248-250 | 249-250 | 241-251 | 242-251 | 247-256 | 247-255 |
| 5 | 246-251 | 249-251 | 249-250 | 246-252 | 249-251 | 247-253 | 244-253 |
| 6 - VGO feed | 248-251 | 249-251 | 249-250 | 246-252 | 249-250 | 249-251 | 249-251 |
| 7 | 249-254 | 245-249 | 249-254 | 249-254 | 245-254 | 246-254 | 245-253 |
| Die/blend | 254-259 | 250-254 | 254-259 | 253-260 | 250-259 | 250-259 | 250-258 |

TABLE 4
Measured process conditions for single-screw extruder

| | | | | | Screen | |
|---|---|---|---|---|---|---|
| | VGO | Injector 1 | Injector 2 | Motor | changer | Screen |
| Tria | temperature | temperature | temperature | amperage | pressure | size |
| # | ° C. | ° C. | ° C. | % | bar | Mesh |
| 1 | 102-103 | 198-201 | 196-201 | 34 | 7 | 3 × 14 |
| 2 | 99-103 | 194-204 | 200 | 34 | 7 | 3 × 14 |
| 3 | 98-105 | 195-202 | 195-202 | 34 | 7 | |
| 4 | 101-102 | 198-202 | 196-203 | 33 | 9 | |
| 5 | 102-104 | 198-202 | 198-202 | 33 | 8 | |
| 6 | 81-104 | 198-202 | 199-201 | 34 | 7 | 2 × 14 |
| 7 | 85-113 | 198-202 | 199-201 | 33 | 7 | |

TABLE 5
Dynamic viscosity and physical aspects of PCW-
VGO blends obtained by single-screw extruder

| | | Dynamic | |
|---|---|---|---|
| PCW | Temperature | viscosity | Physical aspect |
| wt. % | ° C. | cP | at room temperature |
| 0 | 50 | 40.0 | Liquid |
| | 140 | 7.5 | |
| | 180 | 6.3 | |
| | 230 | 5.0 | |
| | 300 | 5.0 | |
| 1.0 | 50 | 742.5 | Liquid, homogeneous |
| | 140 | 33.8 | |
| | 180 | 17.5 | |
| | 230 | 2.5 | |
| | 300 | 1.3 | |
| 2.0 | 50 | — | Liquid, homogeneous |
| | 140 | 85.0 | |
| | 180 | 31.3 | |
| | 230 | 15.0 | |
| | 300 | 11.3 | |
| 5.0 | 50 | 593.3 | Wax, homogeneous |
| | 140 | 22.4 | |
| | 180 | 11.3 | |
| | 230 | 3.8 | |
| | 300 | 2.5 | |
| 8.7 | 50 | — | Wax, homogeneous |
| | 140 | 665.0 | |
| | 180 | 82.5 | |
| | 230 | 35.0 | |
| | 300 | 17.5 | |
| 15.0 | 50 | — | Wax, homogeneous |
| | 140 | 24200.0 | |
| | 180 | 2085.0 | |
| | 230 | 698.3 | |
| | 300 | 227.5 | |
| 32.0 | 50 | — | Solid, homogeneous |
| | 140 | 141300.0 | |
| | 180 | 54500.0 | |
| | 230 | 17400.0 | |
| | 300 | 5270.0 | |
| 50.0 | 50 | — | Solid, homogeneous |
| | 140 | — | |
| | 180 | — | |
| | 230 | 94000.0 | |
| | 300 | 28850.0 | |

One can see from Table 5, a single-screw extruder with two oil injections successfully produced homogeneous plastic waste-oil blends with neither oil nor plastic segregation. Viscosity of 5 wt. % PCW in blend at 300° C. is similar to pure VGO allowing direct feed into FCC. Viscosity of 50 wt. % PCW in blend at 300° C. is close to refinery requirements.

### Example 2A: Twin-Screw Extruder—One Oil Injection Port

The primary mixer was a twin-screw extruder with screw diameter of 26 mm and length to diameter ratio of 44. It has 11 barrels, 1 oil injection port, and 1 die. The oil inlet was located at barrel #5. Oil reservoir was at 100° C. Table 6 lists the feeding conditions, Table 7 the barrel temperatures, Table 8 the process conditions, and Table 9 the dynamic viscosity of PCW-VGO blends. PCW properties are listed in Table 26.

TABLE 6
Feeding condition for twin-screw extruder

| Trial | PCW | VGO | PCW | VGO | Total |
|---|---|---|---|---|---|
| # | wt. % | wt. % | Kg/h | Kg/h | Kg/h |
| 1 | 15.0 | 85.0 | 2.5 | 14.0 | 16.5 |
| 2 | 30.0 | 70.0 | 6.0 | 14.0 | 20.0 |
| 3 | 85.0 | 15.0 | 16.1 | 2.8 | 18.9 |
| 4 | 100 | 0 | 6.0 | 0 | 6.0 |

TABLE 7
Set barrel temperatures of twin-screw extruder

| Barrel | Temperature ° C. |
|---|---|
| # | Trials |
| 1 - PCW | 150 |
| feed | |
| 2 | 150 |
| 3 | 180 |
| 4 | 250 |
| 5 - VGO | 250 |
| feed | |
| 6 | 250 |
| 7 | 250 |
| 8 | 250 |
| 9 | 250 |
| 10 | 250 |
| 11 | 220 |

TABLE 8
Operating conditions for twin-screw extruder

| | VGO | Screw | | Polymer melt |
|---|---|---|---|---|
| Trial | temperature | speed | Torque | pressure |
| # | ° C. | rpm | % max | bar |
| 1 | 120 | 340 | 17 | 0 |
| 2 | 120 | 340 | 25 | 0 |
| 3 | 120 | 700 | 30 | 2 |
| 4 | — | 200 | 39 | 1 |

TABLE 9
Dynamic viscosity and physical aspect of PCW-
VGO blends obtained by twin-screw extruder

| | | Dynamic | |
|---|---|---|---|
| PCW | Temperature | viscosity | Physical aspect |
| wt. % | ° C. | cP | at room temperature |
| 0 | 50 | 40.0 | Liquid |
| | 140 | 7.5 | |
| | 180 | 6.3 | |
| | 230 | 5.0 | |
| | 300 | 5.0 | |
| 15.0 | 50 | — | Wax, homogeneous |
| | 140 | 606.3 | |
| | 180 | 113.8 | |
| | 230 | 25.0 | |
| | 300 | 23.8 | |

### Example 2B: Twin-Screw Extruder—Two Oil Injection Ports

The primary mixer is a twin-screw extruder with screw diameter of 26 mm and length to diameter ratio of 44. It has 11 barrels, 2 oil injection ports, 1 filter, and 1 die. The 1^{st} oil inlet was located at barrel #5, and the 2^{nd} one was at barrel #8. A 40-Mesh screen was used for filtration followed by a die with 120 openings of 1.8 mm of diameter each. Oil reservoir was at 100° C. Table 10 lists the feeding conditions, Table 11 the barrel temperatures, Table 12 the process conditions, and Table 13 the dynamic viscosity of PCW-VGO blends. PCW properties are listed in Table 26.

TABLE 10
Feeding conditions for twin-screw extruder

| Trial | PCW | VGO | PCW | VGO | Total |
|---|---|---|---|---|---|
| # | wt. % | wt. % | Kg/h | Kg/h | Kg/h |
| 1 | 2.5 | 97.5 | 0.78 | 30.42 | 31.20 |
| 2 | 15.0 | 85.0 | 3.60 | 20.40 | 24.00 |

TABLE 11
Barrel temperatures of twin-screw extruder

| | |
|---|---|
| Barrel | Temperature ° C. |

| # | Trial 1 | Trial 2 |
|---|---|---|
| 1 - PCW | 160 | 160 |
| feed | | |
| 2 | 250 | 200 |
| 3 | 250 | 250 |
| 4 | 250 | 250 |
| 5 - VGO | 250 | 250 |
| feed | | |
| 6 | 250 | 250 |
| 7 | 280 | 250 |
| 8 - VGO | 280 | 280 |
| feed | | |
| 9 | 280 | 280 |
| 10 | 280 | 280 |
| 11 | 280 | 280 |
| Die/melt | 257 | 263 |

TABLE 12
Operating conditions for twin-screw extruder

| | VGO | Screw | | Polymer melt |
|---|---|---|---|---|
| Trial | temperature | speed | Torque | pressure |
| # | ° C. | rpm | % max | bar |
| 1 | 85 | 200 | 14 | 1 |
| 2 | 85 | 370 | 17 | 1 |

TABLE 13
Dynamic viscosity and physical aspect of PCW-
VGO blends obtained by twin-screw extruder

| | | Dynamic | |
|---|---|---|---|
| PCW | Temperature | viscosity | Physical aspect |
| wt. % | ° C. | cP | at room temperature |
| 2.5 | 50 | 104.0 | Liquid, homogeneous |
| | 140 | 15.0 | |
| | 180 | 5.0 | |
| | 240 | 2.5 | |
| | 300 | 1.2 | |
| 15.0 | 50 | — | Wax, homogeneous |
| | 140 | 1240.0 | |
| | 180 | 215.0 | |
| | 240 | 68.7 | |
| | 300 | 30.0 | |

One can see the viscosity of 15 wt. % PCW in blend at 300° C. in Example 2B (30 cP) is similar to the one obtained in Example 2A (23.8 cP), which verifies reproducibility of blend properties.

### Example 3: Paddle-Mixer

The primary mixer was a horizontal paddle-mixer 803 with an inner diameter of 260 mm, length of 1,200 mm, and 80 paddles as shown in FIG. 8. PCW was added using a volumetric doser 801, and oil was added using a pump though inlets 815A, 815B. Trials were carried out for 6 min. Table 14 lists the feeding conditions, Table 15 the process conditions, and Table 16 the dynamic viscosity and physical aspect of PCW-VGO blends collected as samples in 805. PCW properties are listed in Table 26. Undissolved polymer, as PET, was retained in the sieve for 2 wt. % PCW in PCW-VGO blend.

TABLE 14
Feeding conditions for horizontal paddle-mixer

| Trial | PCW | VGO | PCW | VGO | Total |
|---|---|---|---|---|---|
| # | wt. % | wt. % | Kg/h | Kg/h | Kg/h |
| 1 | 1.0 | 99.0 | 0.7 | 65.3 | 66.0 |
| 2 | 1.0 | 99.0 | 0.7 | 32.3 | 33.0 |
| 3 | 2.0 | 98.0 | | | |
| 4 | 15.0 | 85.0 | | | |

TABLE 15
Operating conditions for paddle-mixer

| Trial | VGO temperature | Mixer temperature |
|---|---|---|
| # | ° C. | ° C. |
| 1 | 200 | 220 |
| 2 | 200 | 220 |
| 3 | 200 | 220 |
| 4 | 200 | 220 |

TABLE 16
Dynamic viscosity and physical aspect of
PCW-VGO blends obtained by paddle-mixer.

| | | Dynamic | Physical |
|---|---|---|---|
| PCW | Temperature | viscosity | aspect at |
| wt. % | ° C. | cP | room temperature |
| 1.0 | 50 | 90.0 | Liquid, homogeneous |
| | 140 | 6.3 | |
| | 180 | 3.75 | |
| | 230 | 1.25 | |
| | 300 | 1.25 | |
| 1.0 | 50 | 82.5 | Liquid, homogeneous |
| | 140 | 7.5 | |
| | 180 | 6.3 | |
| | 230 | 5.0 | |
| | 300 | 5.0 | |
| 2.0 | 50 | 127.5 | Liquid, homogeneous |
| | 140 | 7.5 | |
| | 180 | 6.3 | |
| | 230 | 5.0 | |
| | 300 | 5.0 | |
| 15.0 | 50 | — | Wax, homogeneous |
| | 140 | 1210.0 | |
| | 180 | 111.2 | |
| | 240 | 45.0 | |
| | 300 | 21.3 | |

One can see the viscosity of 15 wt. % PCW in blend at 300° C. in Example 3 (21.3 cP) was similar to the one obtained in Example 2A (23.8 cP), which shows that similar blend properties can be obtained using different mixers.

### Example 4: Mixing Vessel

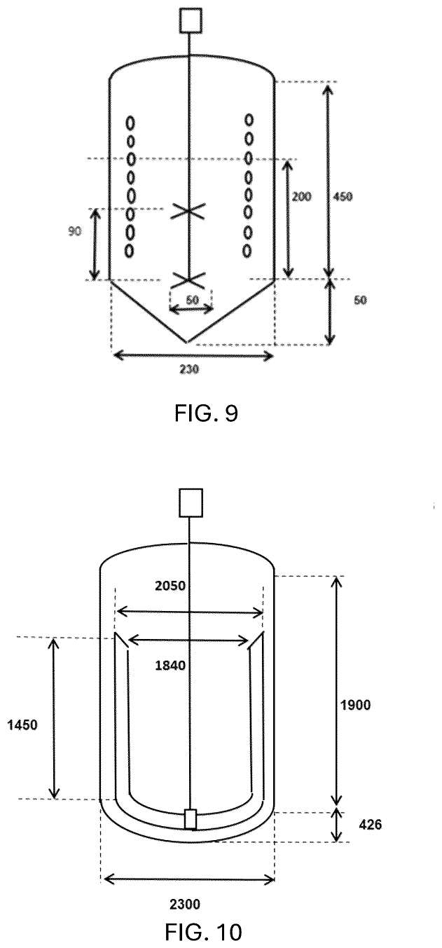

A primary mixer is a vertical mixing vessel with a 1-stage axial impeller, 4PBT type at 45°. Mixing vessel inner diameter of 230 mm and impeller diameter of 50 mm, as shown in FIG. 9. PCW was added manually into the mixing vessel. Mixing was carried out for 30 min. Mixing vessel was kept at 200° C. Table 17 lists the feeding conditions, Table 19 the dynamic viscosity and physical aspect of PCW-VGO blends, and Table 20 Conradson carbon residue for them. PCW properties are listed in Table 26.

TABLE 17
Feeding conditions for vertical mixing vessel

| Trial | PCW | VGO | PCW | VGO | Total |
|---|---|---|---|---|---|
| # | wt. % | wt. % | Kg | Kg | Kg |
| 1 | 1.0 | 99.0 | 0.06 | 5.94 | 6.00 |
| 2 | 5.0 | 95.0 | 0.30 | 5.70 | 6.00 |
| 3 | 10.0 | 90.0 | 0.60 | 5.40 | 6.00 |
| 4 | 15.0 | 85.0 | 0.90 | 5.10 | 6.00 |

TABLE 19
Dynamic viscosity and physical aspects of PCW-
VGO blends obtained by vertical mixing vessel.

| | | Dynamic | |
|---|---|---|---|
| PCW | Temperature | viscosity | Physical aspect |
| wt. % | ° C. | cP | at room temperature |
| 1.0 | 50 | 92.5 | Liquid, homogeneous |
| | 140 | 7.5 | |
| | 180 | 6.3 | |
| | 230 | 3.8 | |
| | 300 | 2.5 | |
| 5.0 | 50 | 3955.0 | Wax, homogeneous |
| | 140 | 50.0 | |
| | 180 | 30.0 | |
| | 230 | 10.0 | |
| | 300 | 5.0 | |
| 10.0 | 50 | — | Wax, homogeneous |
| | 140 | 1405.0 | |
| | 180 | 82.5 | |
| | 230 | 10.0 | |
| | 300 | 5.0 | |
| 15.0 | 50 | — | Wax, homogeneous |
| | 140 | 1388.0 | |
| | 180 | 203.7 | |
| | 240 | 93.8 | |
| | 300 | 41.3 | |

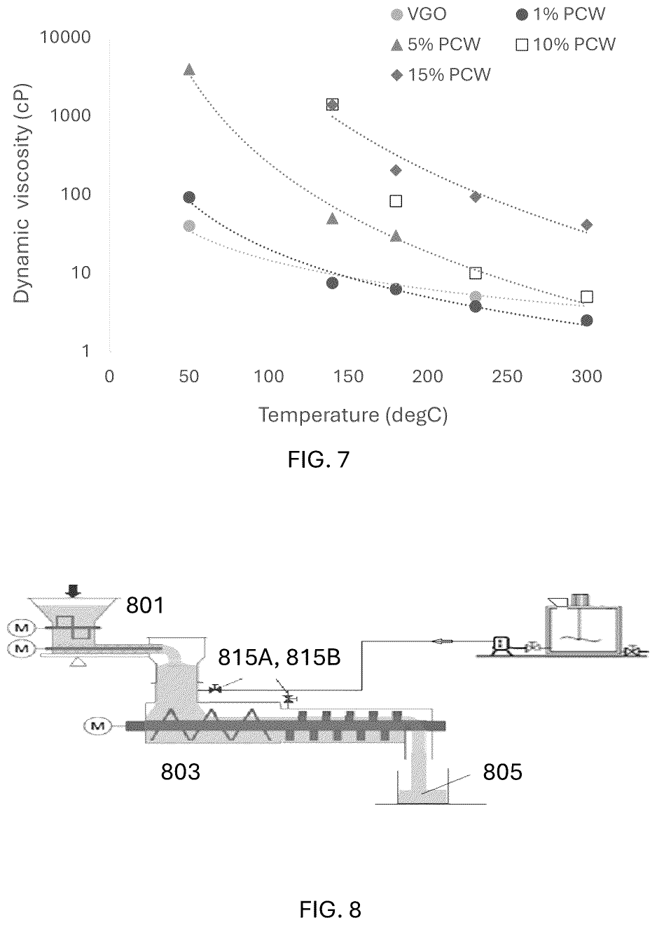

As a non-limiting example, desirable dynamic viscosity is shown in FIG. 7, where vacuum gas oil (VGO) viscosity is 40 cP at 50° C. and 5 cP at 300° C. An increase in PCW-VGO blend viscosity as PCW concentration increases in the blend is shown from 1 to 15 wt. %. Even though viscosity of PCW-VGO blends for >1 wt. % PCW is higher than pure VGO, viscosities of PCW-VGO blends between 5 to 10 wt. % approach VGO viscosity at 300° C.

TABLE 20
Conradson carbon residue of PCW-VGO blends
obtained by vertical mixing vessel.

| PCW | Conradson carbon residue |
|---|---|
| wt. % | wt. % |
| 0 | 0.3 |
| 1 | 0.5 |
| 5 | 0.6 |
| 10 | 0.6 |
| 15 | 1.0 |

The inorganic concentration of a PCW-VGO blend was determined by thermogravimetric analysis. The blend with largest PCW concentration (15 wt. %) had 1.62 wt. % of inorganics when compared against 0.77 wt. % of inorganics for pure VGO. This blend also had a moisture content of 0.5-0.7 wt. %. Hot stage optical microcopy of PCW-VGO blend with 15 wt. % PCW at 200° C. showed undissolved matter size between 0.0041 to 0.061 mm, which cannot clog current industrial FCC feed injectors.

In another case, a mixing vessel using an anchor impeller was designed, as shown in FIG. 10. The anchor type of impeller may promote better heat transfer with a jacketed tank and considering that heat transfer could govern the process to dissolve solid PCW in VGO, this configuration shows promise for a suitable mixing system.

The specific power dissipated (P/V in kW/m³) in media can be used as scale-up factor.

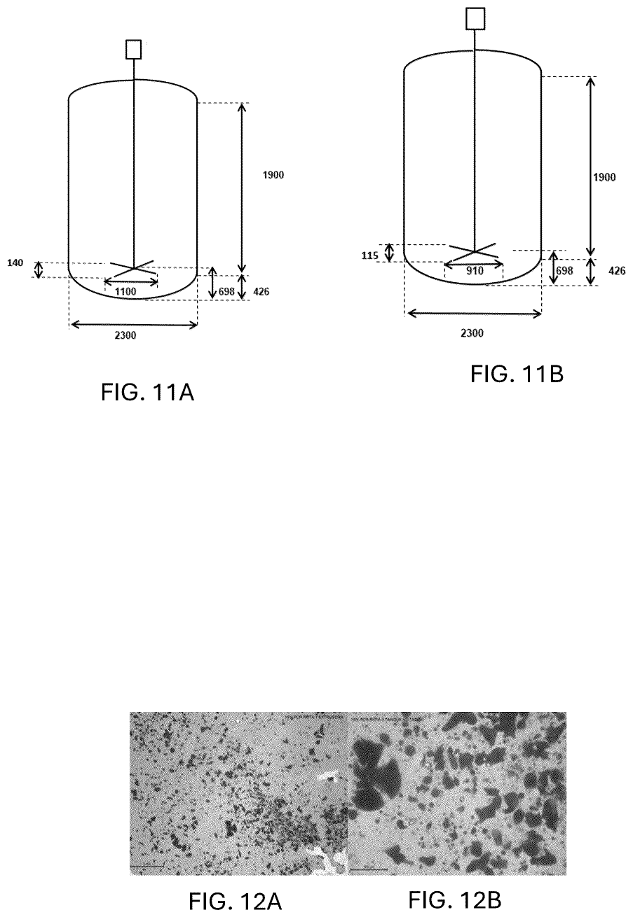

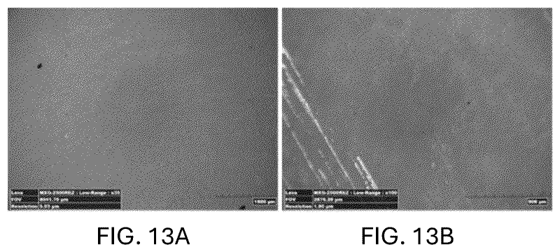

Based on these results, it was possible to design a mixing system using a 10-m³ vessel at industrial scale, which could process 12 to 15 KTA PCW in a refinery. For a standard mixing system, the selected criteria were P/V>0.2 kW/m³ and tip speed>3 m/s. Two configurations were designed to achieve those parameters, as shown in FIGS. 11A and 111B. Both have an ascendent axial flow speed close to tank wall around 1 m/s. Both designs should operate with descendent pump flow direction along the center axis.

### Example 5: Twin-Screw Extruder+Mixing Vessel

The primary mixer is a twin-screw extruder with screw diameter of 26 mm and length to diameter ratio of 44. In the twin-screw extruder mineral oil and PCW are fed directly at the extruder in the concentration of 70% mineral oil and 30% PCW. The PCW and mineral oil mixture is sent to a mixer, as mixing vessel, where PCW-oil blend is diluted to a range from 1% to 20% of PCW. The mixing vessel is described in Example 4 and kept at 200° C. This system has a total volume of 6 L of melted PCW plus oil under continuous stirring for 30 min. 1 to 20 wt. % PCW in PCW-mineral oil blend in the mixing vessel is obtained with high homogeneity and with viscosity inside of refinery specifications. The use of a mixing vessel combined with an extruder is expected to lower equipment costs, since the primary mixer composed only by one extruder may require large processing capacity. Table 21 lists the feeding conditions, Table 22 lists the barrel temperatures of twin-screw extruder, Table 23 lists the operating conditions, and Table 24 lists the dynamic viscosity and physical aspect of PCW-Mineral oil blends.

TABLE 21
Feeding conditions for twin-screw extruder

| Trial | PCW | Mineral oil | PCW | Mineral oil | Total |
|---|---|---|---|---|---|
| # | wt. % | wt. % | Kg/h | Kg/h | Kg/h |
| 1 | 30 | 70 | 6 | 14 | 20 |

TABLE 22
Barrel temperatures of twin-screw extruder

| | Temperature ° C. |
|---|---|
| Barrel # | Trial 1 |
| 1 - PCW | 160 |
| feed | |
| 2 | 200 |
| 3 | 250 |
| 4 | 250 |
| 5 - Mineral | 250 |
| oil feed | |
| 6 | 250 |
| 7 | 250 |
| 8 | 250 |
| 9 | 240 |
| 10 | 230 |
| 11 | 230 |
| Die/melt | 243 |

TABLE 23
Operating conditions for twin-screw extruder

| | Mineral | Screw | | Polymer |
|---|---|---|---|---|
| Trial | Oil | speed | Torque | melt pressure |
| # | ° C. | rpm | % max | bar |
| 1 | 60-80 | 1000 | 18 | 1 |

TABLE 24
Dynamic viscosity and physical aspect of PCW-Mineral oil
blends obtained by twin-screw extruder + missing vessel

| | | Dynamic | |
|---|---|---|---|
| PCW | Temperature | viscosity | Physical aspect |
| wt. % | ° C. | cP | at room temperature |
| 1 | 50 | 228.7 | Liquid, homogeneous |
| | 140 | 11.2 | |
| | 180 | 3.5 | |
| 2.5 | 50 | 2155.0 | Liquid, homogeneous |
| | 140 | 36.2 | |
| | 180 | 16.2 | |
| | 240 | 5.0 | |
| | 300 | 2.5 | |
| 5 | 50 | 18800.0 | Wax, homogeneous |
| | 140 | 241.2 | |
| | 180 | 46.2 | |
| | 240 | 16.2 | |
| | 300 | 10.0 | |
| 10 | 140 | 5038.0 | Wax, homogeneous |
| | 180 | 427.5 | |
| | 240 | 141.3 | |
| | 300 | 40.0 | |
| 20 | 180 | 2555.0 | Wax, homogeneous |
| | 240 | 846.2 | |
| | 300 | 442.5 | |

### Example 6: Colloid Mill

The materials used are agglomerated PCW, properties shown in Table 26, and VGO. Between 10 to 35 wt. % of PCW is fed along with VGO into a single-screw extruder, as described in Example 1. A colloid mill is installed at the outlet end of the extruder. The small fraction of residual plastic particles that are not melted during process at extruder step passes through a colloid mill to disperse the particles in VGO. The energy provided by the high-shear colloidal mill equipment will break up and disperse the undissolved residual plastic particles into the hot oil media. This high shear mixing equipment can be either combined with the primary mixer or operated as an independent mixer. The equipment used for contaminant attrition is a horizontal colloid mill type E or EL. The results of the dispersion show a homogeneous PCW-VGO blend.

### Example 7: Low-Shear Static Inline Mixer

The PCW plastic agglomerate particles are fed to the single-screw extruder and shear melted at a barrel temperature profile of 230° C. The polymer melt exiting the extruder is then fed to the inlet of a 1″ diameter inline Ross low-shear static mixer (~15″ long) which contains 10 mixing elements and combined with VGO oil to yield a final solution containing 5 wt. % polymer. The total throughput is 5 GPM through the Ross mixer that is electrically heated to 300° C. to facilitate mixing and solution. The mixer details are provided in Table 25.

TABLE 25
Characteristics of low-shear static inline mixer

| Parameter | Information |
|---|---|
| Diameter | 1″ |
| Number of elements | 10 |
| Material of construction of elements | Stainless steel 316 |
| Material of construction of housing | Stainless steel 316 |
| Internal surfaces | Media blast finish |
| External surfaces | Media blast finish |
| Housing schedule | 1″ schedule 40 |
| End fittings | 1″ 150# RFSO flanges |
| Retainer ring | Yes |
| Removable Elements | Yes |
| Total length | 15.25″ approx. |

### Example 8: Removal of Aluminum Foil from PCW-VGO Blend

The materials used were agglomerated PCW, properties are shown Table 26 and VGO. Between 10 to 20 wt. % of PCW was fed into a single-screw extruder. As described in Example 1, stainless steel sieves filters were installed at the outlet of the extruder to filter the polymer melt. The contaminant was aluminum. The results of the filtration showed retained aluminum foil on the sieves and a homogeneous and aluminum foil-free PCW-VGO blend.

TABLE 26
Physiochemical properties of agglomerated PCW

| Property | Unit | Value |
|---|---|---|
| Plastic waste | wt. % | 70 LDPE, 15 PP, |
| composition | | 10 LLDPE, 5 PET |
| Physical form | | Solid agglomerated |
| Particle size | mm | D₁₀ = 1.76, D₅₀ = |
| distribution | | 3.34, D₉₀ = 5.80 |
| Density | g/ml | 0.9388 |
| Bulk density | g/ml | 0.3186-0.3397 |
| Ash content | wt. % | ≤1 |
| Cl | wppm | 3248 |
| Ti | wppm | 3210 |
| Si | wppm | 382 |
| Ca | wppm | 217 |
| Al | wppm | 213 |
| Na | wppm | 79 |
| S | wppm | 47 |
| P | wppm | 40 |
| Fe | wppm | 22 |
| Mg | wppm | 21 |
| Cu | wppm | 15 |
| Zn | wppm | 12 |
| K | wppm | 7 |
| Zr | wppm | 4 |

### Example 9: Removal of Inorganic Fines from PCW-VGO Blend

Pelletized PCW (Table 27) was dissolved in VGO in lab using a glass vial at 165° C. The blend was left overnight with no stirring at 165° C. The method of contaminant removal proposed is sedimentation as an independent step. The equipment used here for contaminant removal were swing feeding tanks. One swing feeding tank provided enough resistance time to promote sedimentation. The results presented inorganic fines, shown at the bottom of the glass vial. The remaining PCW-VGO blend was homogeneously mixed.

TABLE 27
Physiochemical properties of pelletized PCW

| Property | Unit | Value |
|---|---|---|
| Plastic waste | wt. % | 50 recycled PE |
| composition | | and 50 virgin PE |
| Physical form | | Solid pellets |
| Particle size | mm | D₁₀ = 3.23, D₅₀ = |
| distribution | | 4.16, D₉₀ = 4.69 |
| Density | g/ml | 0.9560 |
| Ash content | wt. % | 0.1-0.3 |
| Ca | wppm | 1784 |
| Ti | wppm | 1048 |
| Cl | wppm | 240 |
| Si | wppm | 190 |
| Al | wppm | 159 |
| P | wppm | 99 |
| Mg | wppm | 98 |
| Zn | wppm | 96 |
| Fe | wppm | 78 |
| S | wppm | 74 |
| Pb | wppm | 73 |
| Na | wppm | 52 |
| K | wppm | 24 |
| Cr | wppm | 22 |
| Cu | wppm | 21 |
| Sr | wppm | 2 |

### Example 10: Removal of PET from PCW-VGO Blend

The materials used were agglomerated PCW from Example 6 and VGO. 15 wt. % of PCW was fed into a single-screw extruder, as in Example 2A. The PCW was melted and dissolved in oil at 250° C. The contaminant was PET, confirmed by FTIR of a filtrate sample. Optical microscopy images as shown at 8× magnification in FIGS. 12A-12B and 35× magnification in 12B, respectively, showed the undissolved PET. The method used to remove the contaminant was filtration either combined with the primary mixer or as an independent step. The equipment used for contaminant removal included filters and/or sieves. In this trial, the extruder/primary mixer was kept under the melting temperature of PET to allow its further removal from the PCW-VGO blend by filtration.

### Example 11: Removal of Undissolved Polymers from PCW-VGO Blend

The materials used included flakes of PCW and VGO. Before dissolving the flakes into VGO, flakes were micronized. 10 wt. % of micronized PCW was mixed with VGO at 65° C. The blend was poured into a mixing tank with no stirring at 135° C. The contaminants were found to be a mixture of undissolved polymers. The method of contaminant removal was flotation either combined with the mixer or as an independent step. The proposed equipment for contaminant removal was swing feeding tanks. One had enough resistance time to promote flotation. Undissolved polymers were floating on the PCW-VGO blend surface.

### Example 12: Removal of HCl, Siloxanes, and Water from Virgin Resin-Oil Blend

The materials used include Drakeol mineral oil from Penreco and Braskem virgin resin. The procedure included twin-screw extruders in serial mode, with degassing port in the primary extruder and oil injection in the secondary extruder. The contaminants were chlorine, volatile silicon compound(s), and water. The method for contaminant removal was devolatilization either combined with the mixer or as an independent step. The equipment used for contaminant removal included degassing ports under vacuum in the mixer or in its downstream units.

The results included condensable gases which were released from the extruders when bubbled in a water drum. Samples of the scrubber water were collected and analyzed to determine acidity, chlorine content, and silicon content. A Mettler Toledo pH meter was used to measure the condensate's acidity and determine the chlorine concentration. The chlorine content was also determined by mercuric nitrate titrimetric chemistry using a CHEMetrics kit K-2020. The silicon content was determined using an Agilent 5800 ICP-OE spectrometer. Samples were previously acid digested using Milestone UltraWave Single Reactor Chamber. The pH changed from 7.8 to 1.79, and silicon content increased from 6.45 to 8.36 wppm. pH reduced over time due to higher amount of HCl in water. Chlorine concentration was determined from pH measurements. 0.59 Kg of PVC was added into the feed after 164 min of operation, which resulted in 0.33 Kg of chlorine. Therefore, 12 wt. % of chlorine was trapped in the scrubber water and 21 wt. % of PVC was degraded in the first extruder. Neither water nor air bubbles were seen in virgin resin-oil blend by optical microscopy (A and 13B).

### Example 13: Removal of Elements and Oxides from PCW-VGO Blend

Current adsorbents remove contaminants from pure solvent (e.g. pyoil and refinery oil) at temperatures≤250° C. and viscosities up to 1 cP. PCW-oil blends have higher viscosities and need to flow at higher temperatures than pure solvent. Adsorption beds are not considered due to high pressure drop.

The materials include highly porous adsorbents. The procedure to be followed includes placing adsorbents of spherical shape inside of baskets in a mixing tank. The powder adsorbents are placed inside of a mixing tank and the mix can be later filtered. The contaminants include Ca, Ti, Fe, Si, Al, Mg, and Cl. The method of contaminant removal is adsorption and filtration as an independent step. Thus, the equipment used for contaminant removal can include a primary mixer (mixing vessel) with baskets to keep conformed adsorbents, and a mixing tank with powder adsorbents coupled to filters. It is expected that a reduction of element loading will be found in the PCW-oil blend after treatment with adsorbents and filtration.

Embodiments of the present disclosure may provide at least one of the following advantages. One or more embodiments may allow for flexible waste materials to be recycled without significantly altering the refinery processes. Without the need for significant altering, lower capital expenditures may be attained compared to other co-feeding solutions. In addition, one or more embodiments may allow for contaminants and volatile components to be removed prior to introducing recycled waste materials and fluid oil into a refinery process unit within the refinery unit's specifications. This technology may also allow for the acceptance of plastic wastes from other technologies/applications.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

1. A method for recycling a post-consumer waste material comprising:
feeding a post-consumer waste material and optionally a fluid oil into at least one mixer to produce a homogenous blend;
removing contaminants from the homogenous blend to produce a refinery feed stream; and
introducing the refinery feed stream to a refinery process unit.

2. The method of claim 1, wherein the at least one mixer comprises a primary mixer selected from the group consisting of a single-screw extruder, a twin-screw extruder, a mixing vessel and paddle-mixer.

3. The method according to claim 1, wherein the post-consumer waste material comprises at least one polymer selected from the group consisting of: plastic waste polymers, recycled polymers, virgin polymers, or a combination thereof.

4. The method according to claim 1, wherein the refinery process unit is selected from the group consisting of: a delayed coking unit, a fluid catalytic cracking unit, Flexicoking unit, pyrolysis unit, a visbreaking unit, and a hydrocracking unit.

5. The method according to claim 1, wherein the contaminants are at least one selected from the group consisting of: PET, PVC, polyamides, nylon, fillers, additives, catalysts, sand, glass, stainless steel, iron, water, air, oxygen, HCl, and volatile silicon compounds.

6. The method according to claim 1, wherein the post-consumer waste material in the homogenous blend is present at a concentration ranging from 1 to 50 wt % based on a total weight of the homogenous blend.

7. The method according to claim 1, wherein the fluid oil is present at a concentration ranging from 99 to 50 wt % based on the total weight of the homogenous blend.

8. The method according to claim 1, wherein the post-consumer waste material has a physical form selected from the group consisting of: granules, powder, crushed chunks, slurry, films, melt, fines, shavings, chips, pellets, flakes, nurdles, scraps, and mixtures thereof, and wherein the post-consumer waste material comprises a size in a range of 0.1 to 6 mm.

9. The method according to claim 1, wherein the fluid oil is selected from the group consisting of: crude oil, vacuum atmospheric residue, atmospheric residue, vacuum gas oil (VGO), light cycle oil (LCO), heavy mineral oil, and residual oils.

10. (canceled)

11. The method of claim 1, further comprising, before feeding the post-consumer waste material:
introducing the post-consumer waste material to a plastic feeder to dose the post-consumer waste material;
feeding the post-consumer waste material and optionally a first portion of fluid oil to a primary mixer to produce a melted waste material; and
feeding the melted waste material and a remainder of the fluid oil into a secondary mixer to form the homogenous blend.

12. The method of claim 11, wherein:
the primary mixer is selected from a single-screw extruder and a twin-screw extruder; and
the secondary mixer is selected from a mixing vessel, a paddle-mixer, a static inline mixer, a colloidal mixer and a dynamic inline mixer.

13. (canceled)

14. (canceled)

15. (canceled)

16. (canceled)

17. A feed system for recycling a post-consumer waste material comprising:
a plastic feeder for dosing and melting the post-consumer waste material;
a primary mixer and optionally a secondary mixer,
wherein
the primary mixer is for receiving the plastic waste and optionally at least a first portion of fluid oil, and
the secondary mixer is for receiving the melted plastic waste alone or with the optional first portion of fluid oil from the primary mixer, as well as a remainder of fluid oil to form a homogeneous blend;
one or more fluid oil inlets for providing a first portion of fluid oil to the primary mixer and/or optionally the remainder of fluid oil to the secondary mixer, wherein the primary mixer and the secondary mixer are configured to form a homogenous blend from the fluid oil and the melted post-consumer waste material;
a contaminant removal unit connected to the primary mixer and/or the secondary mixer for removing contaminants from the homogenous blend; and
a feed system outlet for feeding the homogenous blend to a refinery oil stream.

18. The system of claim 17, wherein the primary mixer is selected from the group consisting of an extruder, a mixing vessel and a paddle mixer.

19. The system of claim 17, wherein the primary mixer is a single- or twin-screw extruder and the secondary mixer is selected from the group consisting of a mixing vessel, a paddle-mixer, a static inline mixer, a dynamic inline mixer, a colloidal mixer and combinations thereof.

20. (canceled)

21. (canceled)

22. The system according to claim 17, wherein the contaminant removal unit is configured to operate under a pressure that is less than or equal to atmospheric pressure.

23. The system according to claim 17, wherein the one or more fluid oil inlets comprises one or more hydrocarbon inflow conduits fluidly connected to the refinery oil stream to direct a portion of the refinery oil stream as the fluid oil into a primary melting extruder as the primary mixer and/or a secondary mixing extruder as the secondary mixer.

24. A homogeneous blend comprising:
from 1 to 50 wt % of a post-consumer waste material comprising at least one polymer selected from the group consisting of: plastic waste polymers, recycled polymers, virgin polymers, or a combination thereof; and
from 50 to 99 wt % of a fluid oil selected from the group consisting of: crude oil, vacuum atmospheric residue, atmospheric residue, vacuum gas oil (VGO), light cycle oil (LCO), heavy mineral oil, and residual oils,
these amounts being based on a total weight of the homogeneous blend.

25. (canceled)

26. (canceled)

27. The blend according to claim 24, wherein the blend exhibits a maximum viscosity is up to 30,000 cP at 40° C.

28. (canceled)

29. (canceled)

30. The blend according to claim 24, wherein the post-consumer waste materials are derived from materials in a physical form selected from the group consisting of: granules, powder, crushed chunks, slurry, films, melt, fines, shavings, chips, pellets, flakes, nurdles, scraps, and mixtures thereof, and wherein the post-consumer waste material comprises a size in a range of 0.1 to 6 mm.

31. (canceled)
